(19) United States
(12) Patent Application Publication
(10) Pub. No.: US 2008/0246878 A1
(43) Pub. Date: Oct. 9, 2008

(54) Teletext Processing Circuit

(75) Inventors: Johannes Petrus Maria Van Lammeren, Beuningen (NL); Frans Jacob List, Eindhoven (NL); Johan Somberg, Wijchen (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/089,247

(22) PCT Filed: Sep. 29, 2006
(86) PCT No.: PCT/IB06/53569

§ 371 Date: Apr. 14, 2008

(30) Foreign Application Priority Data
Oct. 5, 2005 (EP) 05109211.2

(51) Int. Cl. H04N 7/00

(52) U.S. Cl. 348/468; 348/E07.001

(57) ABSTRACT

The invention relates to a device that comprises a memory circuit with memory cells that use floating gate storage transistors, which are conventionally called non-volatile memory cells. A particular embodiment relates to a teletext circuit. A teletext processing circuit comprising a decoder logic circuit and a memory circuit integrated together in an integrated circuit, the memory circuit comprising memory cells for storing teletext page data, the memory cells comprising floating gate storage transistors to store the teletext page data. The page data from memory is used to control the content of displayed teletext images.

The invention relates to a device that comprises a memory circuit with memory cells that use floating gate storage transistors, which are conventionally called non-volatile memory cells. A particular embodiment relates to a teletext circuit

Teletext circuits have long been known, typically in the form of integrated circuit. As used herein, teletext circuits are circuits that serve to derive “pages” of auxiliary digital data from television signals. Pages refer to teletext pages as well as teletext sub-pages. A television broadcaster transmits a cycle of pages of this type, so that a user who has selected a page number generally has to wait a certain time before the corresponding page can be captured. The more pages are included in the cycle, the longer the waiting time. To reduce waiting time, it has been known to include a memory circuit in the teletext circuit and to store pages in that memory circuit upon reception, before the user has selected these pages. Ideally, all pages should be stored, but when pages for many different page numbers are transmitted this would require a large and therefore costly memory. Accordingly, various techniques have been used to predict selected page numbers for which pages should be stored in advance. However, as large as possible a memory for teletext pages at the lowest possible cost still remains desirable.

Conventionally, SRAM (Static Random Access Memory) or DRAM (Dynamic Random Access Memory) have been used for this purpose. DRAM has the advantage that it has the lowest cost (highest density), but this is only true when the teletext decoding logic circuits and the DRAM are implemented on different integrated circuits. When the decoding logic and the DRAM are combined in the same integrated circuit, costs rise because this requires additional manufacturing steps. Therefore, SRAM has mostly been used in teletext integrated circuits, because SRAM's can be efficiently manufactured with the same processes as the decoding logic circuits. However, SRAMs take up more circuit area than DRAM, making the integrated circuits more expensive.

An even more compact form of memory than DRAM are floating gate memories, such as flash memories. As used herein, “floating gate” refers to a transistor construction wherein a conductive gate material is embedded within isolating material on top of a main transistor channel, generally under a gate electrode that is located on top of the isolating material and in electric contact with a remainder of the circuit. Floating gate memories are generally referred to as “non-volatile memory”, because they are able to retain data for many years without power supply. Floating gate memories have been integrated on the same integrated circuit together with logic circuits. Typically, when a circuit has to contain a non-volatile (flash) memory, a large RAM memory and logic circuits for processing data from these memories one of three approaches is used: either building the circuit from separate integrated circuits for logic circuits and both types of memory, or building the circuit with jointly integrated logic and flash and a separately integrated DRAM, or building the circuit with jointly integrated logic and DRAM and a separately integrated flash. The fourth option: integrating both DRAM and flash together with the logic circuits is not used, because its manufacturing overhead is excessive.

Floating gate memories have not been used or suggested for page storage in teletext circuits, probably because teletext data is the opposite of non-volatile data, many pages being transmitted and replaced in memory a few times per minute. Moreover, floating gate memories suffer from wear. Typical floating gate memories are specified to usable only for about a million write cycles and not more. In a teletext circuit, where a page is transmitted a few times per minute, this end of useful life would be reached after about a year of continuous use. This would be considered too short to be acceptable.

Among others, it is an object of the invention to provide a teletext circuit, which provides for a large page memory that can be easily integrated with teletext decoder logic circuits.

Among others, it is an object of the invention to provide a teletext circuit, which makes use of floating gate memory cells.

More generally, it is an object of the invention to provide for device with a memory circuit with floating gate memory cells, which does not need to rely on long-term non-volatile memory capability of the memory cells.

A teletext processing circuit comprising a decoder logic circuit and a memory circuit integrated together in an integrated circuit, the memory circuit comprising memory cells for storing teletext page data, the memory cells comprising floating gate storage transistors to store the teletext page data. The page data from memory is used to control the content of displayed teletext images. Use of floating gate storage transistors as a memory for teletext page data in an integrated circuit that also contains decoder logic for the page data has the advantage that a large memory can be integrated with the logic circuits without requiring a lot of process overhead. In one aspect this is based on the insight that the prejudice against using floating gate transistor memories does not apply for teletext, because the prejudice is based on the reduction of retention time with too frequent writing. However, having a retention time of years is not relevant for teletext processing circuits, because most teletext pages are refreshed every few minutes and all pages are usually refreshed at least once per hour.

In another aspect a reduced retention time of floating gate storage transistors that are integrated together with processing circuits that write and/or read data from a memory that uses the floating gate storage transistors can be reduced by using a refresh circuit for refreshing the data in the memory. Paradoxically, this increases wear because more write actions are performed, but it makes a lowered retention time acceptable. Because refresh needs to be performed infrequently (much less frequently than in DRAMs), e.g. not more than once per half hour or once per hour, the reduced demand on retention time outweighs the reduction of retention time due to more frequent writing. This aspect can be applied to a teletext processing circuit, but also to other types of processing circuit. In one embodiment refresh is performed by reading data from floating gate transistors and writing back the data to the same floating gate transistors. In an alternative embodiment refresh is performed by writing back to different floating gate transistors, using for example a memory access table (logic to physical address translation table) to locate the data. This can be used to reduce the number of times that data is written to floating gate memory transistors. It may be noted that refresh for floating gate transistors is usually more complicated than for DRAMs. In DRAM refresh is usually inherent in read operations, for floating gates usually a more complicated operation is needed, including copying of data to another memory (area) and writing using high voltages.

In another aspect effects of wear can be reduced by reducing the number of times that the memory is updated. In one embodiment newly received teletext page data, or part thereof, is compared with the stored teletext page data for the same teletext page or part thereof, and writing of the newly received page data is skipped if no change is detected. In a further embodiment skipping is suppressed each time after a receiving newly received teletext page data for the teletext page for a predetermined number of times and/or after a predetermined refresh time interval. Thus, effectively a refresh is realized to cope with any reduced retention time.

In another embodiment a teletext page is reassigned to an address in a different memory sector than a memory sector that previously stored the stored teletext page when the newly received teletext page data differs from the stored teletext page data. In this way it is prevented that more frequently changing pages cause specific memory sectors to wear more quickly.

In another embodiment zapping (changing television channels) is detected and writing of teletext pages into the floating gate memory transistors is delay for some time after zapping to prevent wear due to needless writing. Preferably writing is started within the delay if the user specifically selects a teletext-viewing mode.

In another embodiment the memory has sectors, which define a plurality of memory cells that can be erased simultaneously. For floating gate storage transistors erasing typically requires relatively much time. The sectors have sufficient size for storing a plurality of pages at least so large that a time needed for erasing one sector and writing an amount of page data that fits into the sector is less than a time needed for receiving that amount of page data. Thus, all pages can be written even if the time needed for erasing is relatively long. Optionally the memory supports two different sector sizes (e.g. the possibility to erase selectably either the memory cells of a sector of a first size simultaneously, or to erase simultaneously only the memory cells of a sector that is one of an integer N number (N=4 for example) of sub-sectors of a sector of the first size). In this case the larger size is used when many new pages need to be written (e.g. just after switching to a new channel) and the smaller size is used when only isolated, changed pages need to be written. Thus unnecessary writing is avoided.

Preferably a buffer memory that does not use floating gate transistors is provided, the buffer memory having a much smaller size than the floating gate storage transistor memory, for buffering incoming pages during erasing and writing. Preferably this type of buffer memory is also used to store a copy of a currently displayed page for use to control display, after retrieval from the floating gate storage transistor memory. Optionally, selected pages (pages that have been identified as frequently changing pages) are also kept in such buffer memory, without writing them to the floating gate storage transistor memory each time they have been changed, to reduce wear.

These and other objects and advantageous aspects of the invention will be described with reference to exemplary embodiments using the following Figures.

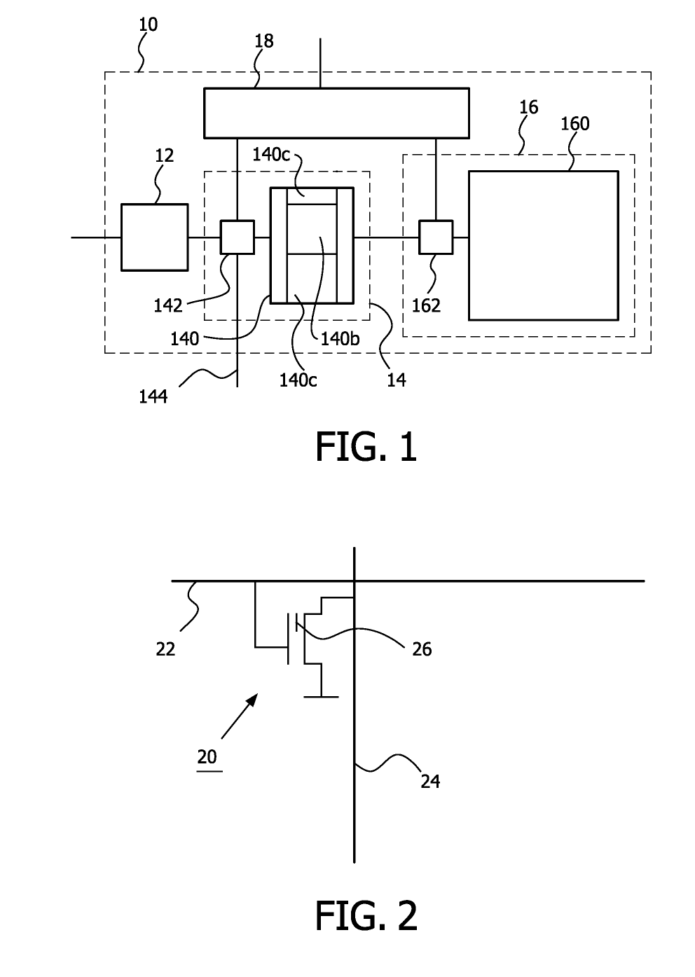

FIG. 1 shows a teletext circuit

FIG. 2 shows a memory cell with a floating gate transistor

FIG. 1 shows a teletext integrated circuit 10. The circuit comprises decoder logic circuit 12, a buffer memory unit 14, a main memory unit 16 and a control circuit 18. Buffer memory unit comprises a buffer memory 140, a buffer memory interface 142 and a display control output 144. Buffer memory 140 is implemented for example using a conventional SRAM matrix memory. Buffer memory 140 has ports coupled to buffer memory interface 142 and main memory unit 16. Buffer memory interface 142 has an input coupled to decoder logic circuit 12 and an output coupled to display control output 144. Main memory unit comprises a main memory 160 with a matrix of floating gate cells, and a main memory interface 162, coupled between buffer memory 140 and main memory 160. Control circuit 18 has control connections coupled to buffer memory interface 142 and main memory interface 162.

In operation decoder logic circuit 12 receives a television signal or a signal derived from a television signal and decodes digital teletext data from this signal. As used herein, teletext data is data derived from auxiliary digital data in a television signal. The term teletext is not limited to signals of this type in television channels that are specifically called “teletext” by broadcasters. As used herein, teletext data includes, but is not limited, to character information for display of pages of text on a display screen. As another example the teletext data may comprise graphics control codes. Decoder logic circuits for decoding teletext signals are known per se. Decoder logic circuit 12 writes the decoded data to buffer memory 140 via buffer memory interface 142.

FIG. 2 shows part of main memory 160 (only one memory cell being shown explicitly. Main memory 160 typically contains a matrix with word lines 22 (only one shown) and bit lines 24 (only one shown). Each memory cell contains a floating gate transistor 20 with a floating gate 26 between its gate and its main current channel.

Main memory 160 comprises a memory circuit with a matrix of floating gate storage transistors, constructed for example as a conventional flash memory, the construction of which is known per se. Manufacturing steps for manufacturing logic integrated circuits and the additional steps for manufacturing floating gate storage transistors are known per se. Typically a higher memory cell density can be realized than for SRAMs, but write actions for floating gate memories are typically are relatively slow (compared to SRAMs and read operations). Adding a DRAM as well would require excessive overhead. Flash memory is often needed in integrated circuits with logic circuits when non volatile storage is needed in a circuit, but it would require excessive overhead to add an efficient DRAM in such integrated circuits.

Main memory interface 162 controls write actions into main memory 160, writing data from a memory write area of buffer memory 140. To simplify access to buffer memory 140 first and second independently accessible areas 140a,b may be provided in buffer memory 140, one being coupled to main memory interface 162 as a memory write area while the other is coupled as an input area to buffer memory interface 142 for accepting data from decoder logic circuit 12, the connections to the areas 140a,b being switched each time when all page data from the memory write area has been written to main memory 160.

Main memory interface 162 also controls read actions for reading an addressed page from main memory 160 and writing the data for the addressed page to third area 140c (for example an independently accessible area or alternately a part of areas 140a,b). Buffer memory interface 142 provides for output of data for the page from third area 140c to display control output 144, optionally after processing by character generator circuit or graphics generator (not shown) at a rate required for display.

Control circuit 18 controls operation in interaction with buffer memory interface 142 and main memory interface 162. Control circuit 18 receives identifications of the pages that are received from decoder logic circuit 12 and decides which of these pages should be stored in main memory 160. For those pages control circuit 18 selects and the memory locations in main memory 160 where these pages should be stored, causing main memory interface 162 to start write actions for these sectors. Control circuit 18 signals to main memory interface 162 which pages should be stored. Control circuit 18 and/or main memory interface 162 select at which addresses of main memory 160. For control purposes no strict distinction can be made between control circuit 18 and main memory interface 162. For the sake of simplicity the combination will be referred to as control circuit.

Concurrently, control circuit 18 receives user selection signals that indicate which page should be displayed and sends control signals to main memory interface 162 to copy this page from main memory to third area 140c if it is not already stored there. When no write action is in progress copying can be performed substantially immediately. Otherwise copying is preferably delayed until the write action has been completed.

Various techniques may be used for selecting addresses of main memory 160 for storage of pages, or lines of pages. In a simple embodiment a predetermined memory address range is assigned to each page number. In this embodiment control circuit 18 simply uses the page numbers to select the corresponding predetermined address range. In a more complicated embodiment a variable relation between page numbers and addresses is used. In this embodiment control circuit 18 may maintain a translation table (for example in buffer memory 140) with addresses that have been assigned to different pages. In this way addresses can also be assigned to sub-pages, so that different address ranges can be assigned to different sub-pages of the same page for concurrent storage. In one embodiment part of the pages is assigned to predetermined addresses and variable assignment is provided only for sub-pages, or only for sub-pages and/or for pages that are frequently changed. In a further embodiment addresses may be assigned to lines within (sub-)pages, this makes it possible to make efficient use of memory in the case of variable length pages.

In one embodiment reassignment for frequently changed pages is done automatically, by reassigning a page to a new address range that does not overlap with its old address range (more generally: for which writing does not require previous erasing of memory cells in that old address range) when a change is detected in the page. Alternatively certain pages may be identified in advance as frequently changing pages and these identified pages may be assigned to varying addresses. In yet another embodiment frequently changing pages may be identified by maintaining statistics of page changes for different page numbers in control circuit 18.

In a further embodiment a limited number of very frequently changing pages, such as sub-title pages or “latest news” pages are not stored in main memory 160, or at least not updated in main memory 160 after every change. When control circuit 18 identifies such a page, by any of the previously discussed techniques, it controls that the page remains stored in buffer memory 140, for example in third area 140c, and does not signal to main memory interface that this page should be stored.

The variable relation may be used for example if main memory 160 is too small to store all teletext pages. In this case control circuit 18 makes a selection of page numbers and/or sub-page numbers of pages that should be stored. Any method may be used to make such a selection, for example by selection from a list of N pages (N=50 for example) that have been most recently selected or a list of pages that have been most frequently selected, or selection of next adjacent pages to a currently viewed page, or sub-pages of a currently viewed page or adjacent pages of the currently viewed page. Also, the variable relation may be used to allocate mutually different amounts of storage for pages that are represented by mutually different amounts of data, by assigning start addresses of successively stored pages each at a predetermined distance from the end of the stored data for the preceding page.

In a further embodiment measures are taken to minimize the number of times that data is overwritten in main memory 160. In a first such embodiment main memory interface 162 is arranged to read data from the addressed memory locations before the write action and to compare that data with data stored in the memory write area of buffer memory 140. When main memory interface 162 detects no difference it skips the write action. Thus, the content of locations of main memory 160 will not be rewritten upon reception of teletext pages that have not changed since the previous writing.

In a yet further embodiment main memory interface 162 proceeds with the write action even if there is no difference if the last write action was more than a predetermined time interval in the past. Thus, the effect of leakage of stored charge is counteracted. Instead of using the predetermined time interval as a criterion, the predetermined minimum number of receptions of a page may be used as a criterion not to skip writing. In this embodiment information about the time of writing or about the number of times a page has been received is preferably stored, for example in buffer memory 140 for use in the decision whether to skip writing. Preferably the time interval before a write action is forced is shorter but of the same order of magnitude as the retention time of the floating gate memory, e.g. at least half an hour or one hour.

In an alternative embodiment leakage may be counteracted by means of re-writing using data from main memory 160. In this embodiment main memory interface 162 is arranged to determine for respective sectors of main memory 160 whether a predetermined time interval has elapsed since the sector was written (e.g. by resetting time counts for the respective sectors when they are written into, periodically updating the time counts and comparing the time counts with a threshold, or by saving a time of writing indication and comparing it with a current time). When it is determined (e.g. by control circuit 18 or main memory interface 162) that the time interval has elapsed the sector is read from main memory 160, written into buffer memory 140 and written back into main memory 160 (not necessarily in the same sector). The predetermined time interval is preferably selected to be shorter than the floating gate retention time of the floating gate transistors in main memory. When transistors with a short retention time (e.g. 30-60 minutes) are used, the time interval will be less than that retention time.

In another embodiment control circuit 18 is arranged to detect zapping and to disable write actions into main memory 160 when zapping has been detected. In one embodiment control circuit 18 disables write actions for a predetermined time interval (of e.g. between 1-10 seconds, say 5 seconds) after detecting a television channel change. In a further embodiment control circuit 18 enables write actions in this time interval after detecting that the user has switched to teletext mode viewing.

In yet another embodiment measures are taken to handle noise. When a new version of a page has been received and an old version is stored in main memory 160, main memory interface 162 compares the pages to detect whether the pages (or lines thereof) differ only by difference that can be attributed to errors (e.g. because a checksum for one or both is incorrect) and replaces the page (or line) in main memory only if the stored page (or line) is detected to be incorrect and the new page (or line) is detected to be correct.

Preferably, main memory 160 is organized into sectors of memory locations that are erased together under control of a common erase signal before new data can be written into selected memory locations in the sector. One example of this type of organization is known from the flash memory design art. This type an organization increases memory density. In this type of memory one embodiment of the write action involves first erasing all memory cells in the sector where data must be written and subsequently writing the data to different addresses in the sector.

In one embodiment the memory is constructed so that size of each sector corresponds to the storage space needed for a single page. This simplifies management of the pages. However, this selection of sector size may lead to problems because in some memories the time needed for a write action including erase and writing is several times longer than the time used to transmit a teletext page in a television signal. Erasing typically takes some 100 milliseconds per sector and writing takes some 1 millisecond per write unit. After a user has switched to a new channel, when many new pages must be stored this may have the effect that buffer memory contains too little memory to buffer pages that are waiting for writing.

In one embodiment, this problem is solved by using sectors in main memory 160 of a size that provides for storage of at least a number N of pages so that the average transmission time of this number N of pages in a television signal is less than the time needed for a write action for this number of pages. Since much of the time in the write action is taken by erasing, a sector size that covers a plurality of pages, so that the memory space for these pages can be erased simultaneously makes it possible to share the erase time between for these pages. In this embodiment pages are collected from decoder logic circuit 12 in the input area of buffer memory 140 until main memory interface 162 is ready to start a write action for those pages.

Preferably, a write action is delayed until a predetermined number of N pages that fit in a sector have been received. In this embodiment the N pages may be handled as a unit. That is, in the embodiments where storage of pages is skipped, when the pages have been stored, data for all pages that have been stored in a same sector is preferably first collected in buffer memory 140 and the data for all these pages is compared with data from main memory 160, writing being skipped if none of the pages has changed. Alternatively, the data for the pages that have not changed may be first dropped from buffer memory 140 and later reloaded from main memory 160 if writing of the sector is needed.

However, replacing the data for N pages as a unit has the disadvantage that relatively frequent writing may be needed at many locations. To reduce the number of write actions per location, main memory 160 may be arranged to support at least two selectable modes of erasing, wherein a sector of no more size than needed for a single page or a combination of N sectors are erased respectively. In this embodiment data for incoming pages buffered in buffer memory 140 at least until a previous write action has been completed and then, if necessary, a next write action is started for the buffered data. If only one of the pages has changed main memory interface 162 controls main memory 160 to erase a sector for the page in the mode wherein only one sector in the next write action. If more pages need to be replaced main memory interface 162 controls main memory 160 to erase in the mode wherein N sectors are erased, where N is at least as large as the number of pages that can be transmitted in a television signal during a write action. Optionally, data from the relevant sectors is copied from main memory 160 before erasing for use in rewriting, but this may not be necessary if the data is also received from decoder logic circuit 12. Subsequently main memory interface 162 writes as many pages to main memory 160 as required due to erasing.

In another embodiment, in the case where memory locations are assigned to pages by means of an adaptable translation table, erasing and writing may be decoupled. In this case main memory interface 160 autonomously erases selected sectors that store pages that are predicted not to be used. When a new page has to be written main memory interface 160 assigns this pages to an erased sector.

When memory locations are assigned to pages by means of an adaptable translation table, and sectors are used that contain a plurality of pages in one embodiment variable combinations of pages may be assigned to a sector. In this case, when memory interface 160 determines that one of the pages has changed, this page may be marked invalid in an existing sector and the changed page may be written in another sector that contains free space. This minimizes the need to rewrite, but has the disadvantage that main memory 160 may not be used efficiently.

Preferably frequently updated pages are not always stored in the same sector. This can be avoided e.g. by assigning a new sector to a page for storage of the page when it has been determined that the page has changed. In this case a translation table may be used to indicate where the latest version of the page is stored.

Because the circuit does not rely on very long retention times, the design of the floating gate transistors in main memory 160 and high voltage generators used for erasing and/or writing may be optimized without much regard for retention time. It is preferred that the retention time does not change much rather than that the retention time is very long. For example, a thickness of the isolator (e.g. silicon oxide) between the floating gate and the main current channels may be smaller than in conventional floating gate memories, reducing the retention time. E.g. a thickness that leads to a retention time between one hour and a day, or between one hour and a month or a year may be used. These retention times are normally unacceptable in non-volatile memory, but because teletext pages are received repeatedly and/or refresh from main memory 160 is used, this is not a disadvantage. In return a high voltage generator circuit for writing and/or erasing needs to generate lower voltage than for conventional floating gate memories, which reduces, wear.

Although the invention has been described for a teletext circuit, it should be appreciated that alternatively a floating gate memory may be used to store data in other types of circuit wherein refreshed data is received at a regular rate, or wherein the data in the floating gate memory is refreshed at a regular rate. Memory refresh is of course well known from DRAM's, but in the present case it is applied to floating gate transistor memory, which is normally regarded as non-volatile memory. The refresh rate is preferably kept very low (much lower than in DRAMs) to reduce wear, for example less than once per half hour, or less than once per hour or even less than once a day or once a week, dependent on the retention time of the floating gate memory transistors, which need not be optimized (as is the case for conventional floating gate transistor memories), but is still much longer than that of capacitors in DRAMs.

1. A teletext processing circuit comprising a decoder logic circuit and a memory circuit integrated together in an integrated circuit, the memory circuit comprising memory cells for storing teletext page data, the memory cells comprising floating gate storage transistors to store the teletext page data.

2. A teletext processing circuit according to claim 1, comprising a control circuit arranged to refresh the teletext page data for a teletext page in the memory circuit, by writing newly received teletext page data for that teletext page into the memory cells, the control circuit being arranged to compare the newly received teletext page data, or part thereof, with the stored teletext page data for the teletext page or part thereof, the control circuit being arranged to skip writing the newly received page data if no change is detected.

3. A teletext processing circuit according to claim 2, wherein the control circuit is arranged to suppress skipping each time after a receiving newly received teletext page data for the teletext page for a predetermined number of times and/or after a predetermined refresh time interval.

4. A teletext processing circuit according to claim 1, wherein the control circuit that is arranged to maintain an assignment of respective teletext pages to variably selectable addresses in the memory circuit, the control circuit being arranged to reassign the teletext page to an address in a different memory sector than a memory sector that stores the stored teletext page data and to write the newly received teletext page data to the reassigned address when the newly received teletext page data differs from the stored teletext page data.

5. A teletext processing circuit according to claim 1, comprising a control circuit arranged to refresh the teletext page data in the memory using retrieved page data from the memory cells.

6. A teletext processing circuit according to claim 5, wherein a refresh rate of said refreshing is less than once per half hour.

7. A teletext processing circuit according to claim 1, comprising a control circuit arranged to detect occurrence of a television reception channel and to disable writing of page data into the memory cells until a predetermined time interval has elapsed after the channel change.

8. A teletext processing circuit according to claim 7, wherein the control circuit is arranged to enable writing within said predetermined time interval when activation of a teletext mode is detected.

9. A teletext processing circuit according to claim 1, comprising a control circuit and wherein the memory cells are organized into sectors, the control circuit being arranged to control simultaneous erasing of all memory cells in a selected sector before writing teletext page data into memory cells in the sector, the sectors having a size that is at least so large that a time needed for erasing one sector and writing an amount of page data that fits into the sector is less than a time needed for receiving that amount of page data.

10. A teletext processing circuit according to claim 9 comprising an SRAM or DRAM buffer memory, arranged to buffer at least said amount of page data during erasing of the sector.

11. A teletext processing circuit according to claim 1, comprising an SRAM or DRAM buffer memory and a control circuit, the control circuit being arranged to identify one or more selected pages, and to keep page data for these one or more identified pages in the buffer memory without writing the one or more identified pages to the memory cells, or at least without writing data for the one or more identified pages to the memory cells after every change in the one or more identified pages.

12. An integrated circuit for processing a teletext signal, the integrated circuit comprising a decoder logic circuit and a memory circuit integrated together on a same semi-conductor substrate, the memory circuit comprising memory cells for storing teletext page data, the memory cells comprising floating gate storage transistors to store the teletext page data.

13. An integrated circuit comprising a data processing circuit, a memory circuit and a refresh circuit, the memory circuit comprising memory cells that comprise floating gate transistors, coupled to the data processing circuit for storing data produced by the logic circuit and/or for supplying stored data for processing by the data processing circuit, the refresh circuit being arranged to refresh data in the memory by reading data from the memory cells and writing back the data that has been read back to the memory cells at a same or a different address.

14. A method of processing teletext page data, the method comprising storing received teletext page data in floating gate storage transistors, retrieving the teletext page data from the floating gate storage transistors and controlling image display with the retrieved the teletext page data.
